(19) United States
(12) Patent Application Publication
(10) Pub. No.: US 2021/0083513 A1
(43) Pub. Date: Mar. 18, 2021

(54) CHARGING DEVICES AND METHODS FOR USING THEM

(71) Applicant: GLOBAL TRADE & TECHNOLOGY CORP., Lake Forest, CA (US)

(72) Inventors: Ammar Adra, Ladera Ranch, CA (US); Qingjun Wang, Shenzhen (CN)

(21) Appl. No.: 17/024,525

(22) Filed: Sep. 17, 2020

Related U.S. Application Data
(60) Provisional application No. 62/901,707, filed on Sep. 17, 2019.

(51) Int. Cl. H02J 50/10; H02J 50/00; H02J 7/00

(52) U.S. Cl. CPC H02J 50/10; H02J 7/0063; H02J 50/005

(57) ABSTRACT

A charging station is provided for charging electronic devices that includes a housing comprising a back panel including one or more electrical connectors configured for placement against surface adjacent an outlet such that the one or more electrical connectors may be coupled to the outlet, one or more ports configured to receive charging cables from electronic devices, and a power distribution circuit within the housing for delivering electricity from the outlet coupled to the one or more electrical connectors and the one or more ports. A charging tray is mounted to the housing such that the charging tray is movable between a storage position and an active position, the charging tray including one or more slots for receiving an electronic device during charging.

### RELATED APPLICATION DATA

The present application claims benefit of co-pending U.S. provisional application Ser. No. 62/901,707, filed Sep. 17, 2019, the entire disclosure of which is expressly incorporated by reference herein.

### FIELD OF THE INVENTION

The present invention relates to devices for charging electronic devices, and, more particularly, to charging station devices for charging electronic devices, such as cellphones, tablets, wireless headphones, watches, GPS devices, ear buds, powerbanks, laptops, and the like, and to methods for using such devices.

### BACKGROUND

Portable electronic devices, such as cellphones, tablets, wireless headphones, watches, GPS devices, and the like, have become ubiquitous in modern society. An individual may have multiple devices, each of which must have their batteries routinely recharged to keep them operational. Many of these devices have their own charging cables, which must be kept and plugged into available outlets to recharge the devices, which can be difficult, particularly when only a single electrical outlet is available to an individual with multiple devices.

More recently, many electronic devices include inductive charging capabilities, e.g., including internal inductive coils or circuits coupled to their batteries, such that the electronic devices may be placed on an inductive charger to recharge their batteries without connecting a cable. However, each of these chargers themselves include cables that must be plugged into available outlets to power the charging devices. Although inductive chargers can be more convenient, given that an electronic device can simply be placed on the charger without requiring connecting a cable, an individual must still keep a power cable for each of their inductive chargers. Thus, an individual with multiple chargers must still keep multiple power cables, which, along with other cables for the electronic devices, may be difficult to organize. Further, an individual with multiple chargers may still need multiple electrical outlets if they want to charge multiple devices simultaneously.

Therefore, charging devices that facilitate charging multiple electronic devices simultaneously would be useful.

### SUMMARY

The present invention is directed to charging devices for charging electronic devices, and, more particularly, to charging station devices for charging multiple electronic devices simultaneously, such as cellphones, tablets, wireless headphones, watches, GPS devices, ear buds, powerbanks, laptops, and the like, and to methods for using them.

In accordance with one embodiment, a charging station is provided for charging electronic devices that includes a housing comprising a back panel including one or more electrical connectors configured for placement against a surface adjacent an outlet such that the one or more electrical connectors may be coupled to the outlet, one or more ports configured to receive charging cables from electronic devices, and a power distribution circuit within the housing for delivering electricity from the outlet coupled to the one or more electrical connectors and the one or more ports. A charging tray is mounted to the housing such that the charging tray is movable between a storage position and an active position, the charging tray comprising one or more slots for receiving an electronic device during charging.

Optionally, the charging stations described herein may replace cover plates of conventional electrical power sockets, e.g., to provide a convenient location for charging multiple electronic devices. In addition or alternatively, the charging stations may facilitate tidying up a user's charging section, reducing the amount of clutter and providing a concise small are for charging all of the user's electronic devices. Thus, the user may avoid having multiple chargers and/or cables lying around where they normally charge their devices. Such a charging station mat eliminate the need for a night stand or other piece of furniture dedicated to or overwhelmed by charging devices.

In accordance with another embodiment, a charging station is provided for charging one or more electronic devices, e.g., multiple devices simultaneously, that includes a housing comprising a front panel, one or more side panels, and a back panel opposite the front panel including one or more electrical connectors, the back panel configured for placement against a surface adjacent an electrical outlet such that the one or more electrical connectors may be coupled to one or more respective sockets of the electrical outlet; one or more ports configured to receive connectors from charging cables from electronic devices; and a power distribution circuit within the housing for delivering electricity from the electrical outlet via the one or more electrical connectors to the one or more ports. The charging station also includes a charging tray rotatably mounted to the housing such that the charging tray is movable between a storage position and an active position that includes a ledge that is oriented substantially parallel to the front panel in the storage position and is oriented substantially perpendicular to the front panel in the active position; a plurality of separators fixed to the ledge such that the separators are spaced apart from one another on the ledge, extend substantially perpendicular to the ledge, and the separators are oriented substantially parallel to the front panel when the charging tray is in the active position, wherein adjacent separators define slots therebetween for receiving an electronic device for charging, and spool attached to the charging tray below the ledge around one or more cables may be wrapped.

In accordance with still another embodiment, a method is provided for mounting a charging station including a housing including a front panel, a back panel opposite the front panel that includes one or more electrical connectors, and one or more ports electrically coupled to one or more electrical connectors for charging one or more electronic devices connected to the one or more ports. The method may include removing a cover plate of an electrical outlet in a wall; inserting the one or more electrical connectors into respective one or more sockets of the electrical outlet; and directing a fastener into an opening in the housing through the front and back panels, and into a fastener hole in the electrical outlet to secure the housing relative to the wall.

In accordance with yet another embodiment, a method is provided for charging one or more electronic devices that includes providing a charging station comprising a housing including a front panel, one or more side panels, a back panel opposite the front panel that includes one or more electrical connectors, one or more ports electrically coupled to one or more electrical connectors, and a charging tray mounted to the housing such that the charging tray is movable between a storage position and an active position, the charging tray comprising a ledge and a plurality of separators fixed to the ledge such that the separators are spaced apart from one another on the ledge and extend substantially perpendicular to the ledge; inserting the one or more electrical connectors into respective one or more sockets of the electrical outlet; connecting a cable to a first port of the one or more ports; connecting the cable to an electronic device to charge the electronic device; positioning the charging tray in the active position wherein the ledge is oriented substantially perpendicular to the front panel and the separators are oriented substantially parallel to the front panel; and placing the electronic device in a slot adjacent one of the separators.

In accordance with still another embodiment, a method is provided for charging one or more electronic devices that includes providing a charging station comprising a housing including a front panel, one or more side panels, a back panel opposite the front panel that includes one or more electrical connectors, one or more ports electrically coupled to one or more electrical connectors, and a charging tray mounted to the housing such that the charging tray is movable between a storage position and an active position, the charging tray comprising a ledge and a plurality of separators fixed to the ledge such that the separators are spaced apart from one another on the ledge and extend substantially perpendicular to the ledge; inserting the one or more electrical connectors into respective one or more sockets of the electrical outlet; placing an inductive charger in a receptacle in a first separator of the separators; and connecting a cable of the inductive charger to a first port of the one or more ports such that an electronic device placed within a first slot adjacent the receptacle may be inductive charged by the inductive charger.

Other aspects and features of the present invention will become apparent from consideration of the following description taken in conjunction with the accompanying drawings.

### BRIEF DESCRIPTION OF THE DRAWINGS

The drawings illustrate exemplary embodiments of the invention, in which:

FIGS. 1A-1C are perspective views of an exemplary embodiment of a charging station including a movable charging tray in a storage position.

FIG. 1D-1I are front, back, bottom, top, right side, and left side views, respectively, of the charging station of FIGS. 1A-1C.

FIGS. 2A-2C are perspective views of the charging station of FIGS. 1A-1D with the charging tray in an active position for receiving electronic devices for charging on the tray.

FIG. 2D-2I are front, back, bottom, top, right side, and left side views, respectively, of the charging station of FIGS. 2A-2C.

FIGS. 3A and 3B show the charging station with the charging tray moved to the active position and receiving a smart watch for inductive charging.

FIGS. 4A-4C show various configurations for receiving a smart watch on the charging tray for inductive charging.

FIGS. 5A-5E show exemplary circuits that may be provided in the charging station of FIGS. 1A-2I.

### DETAILED DESCRIPTION OF THE EXEMPLARY EMBODIMENTS

Before the exemplary embodiments are described, it is to be understood that the invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

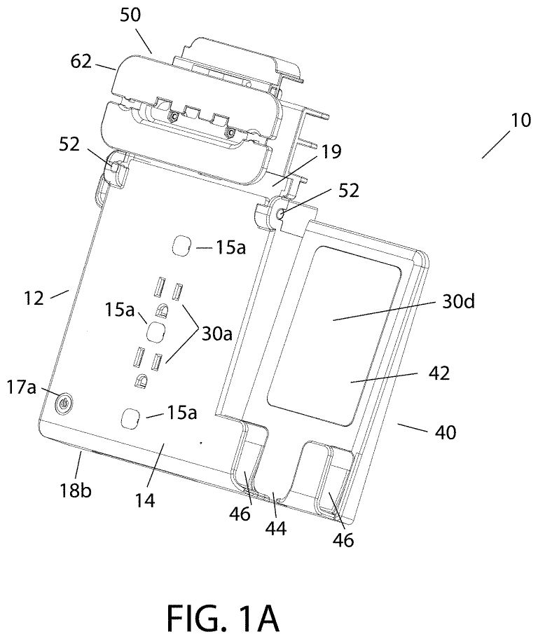

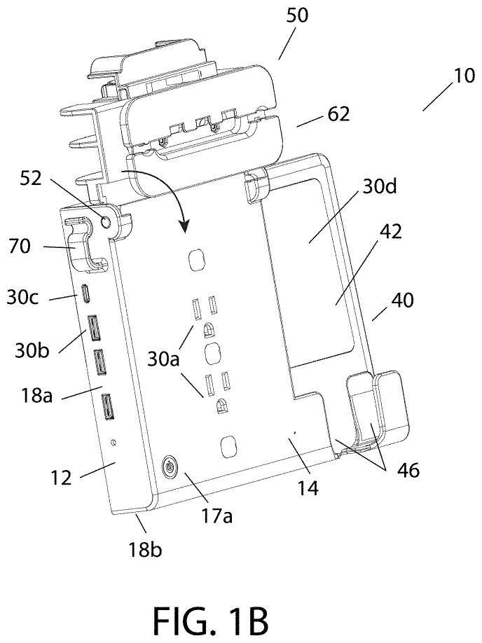

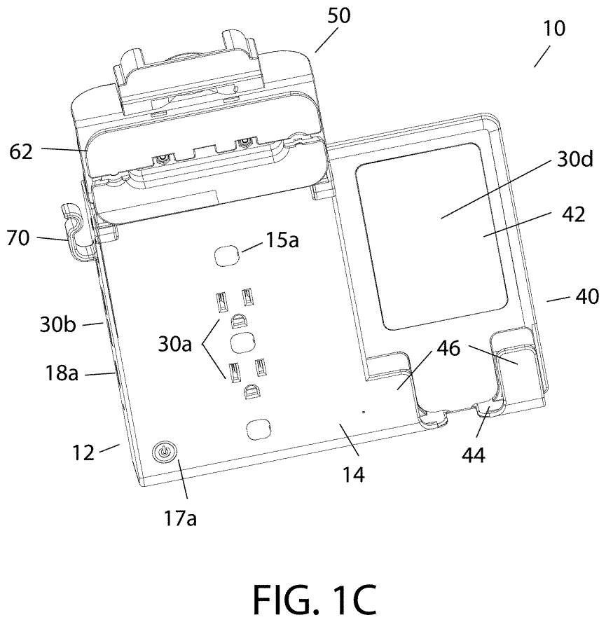

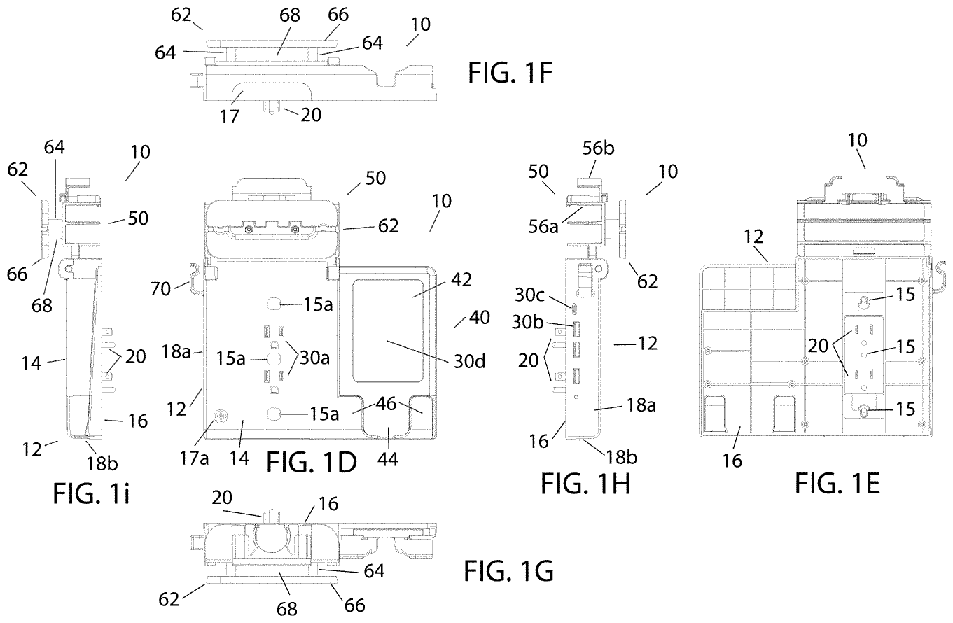

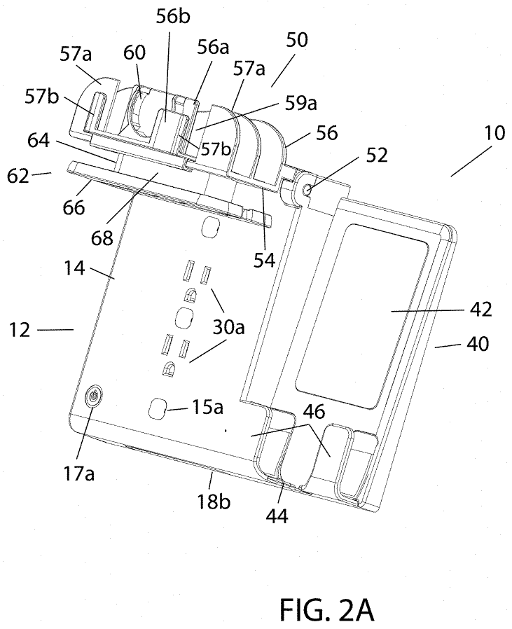

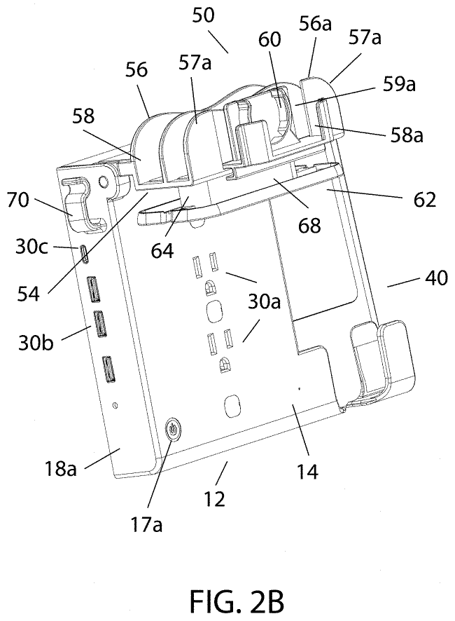

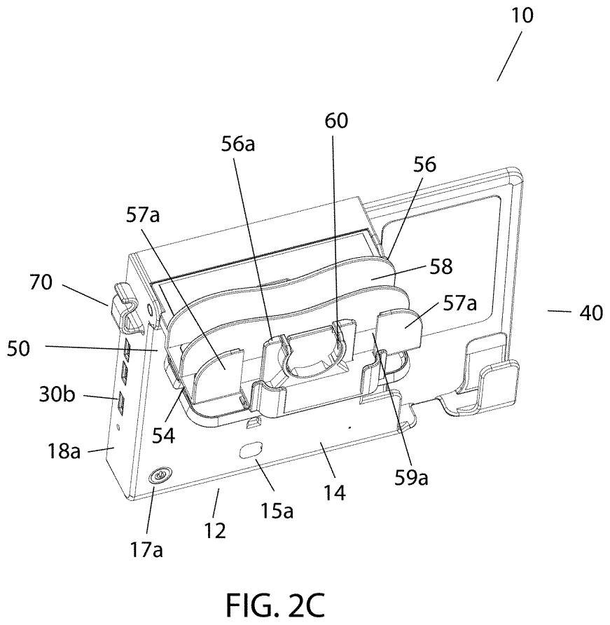

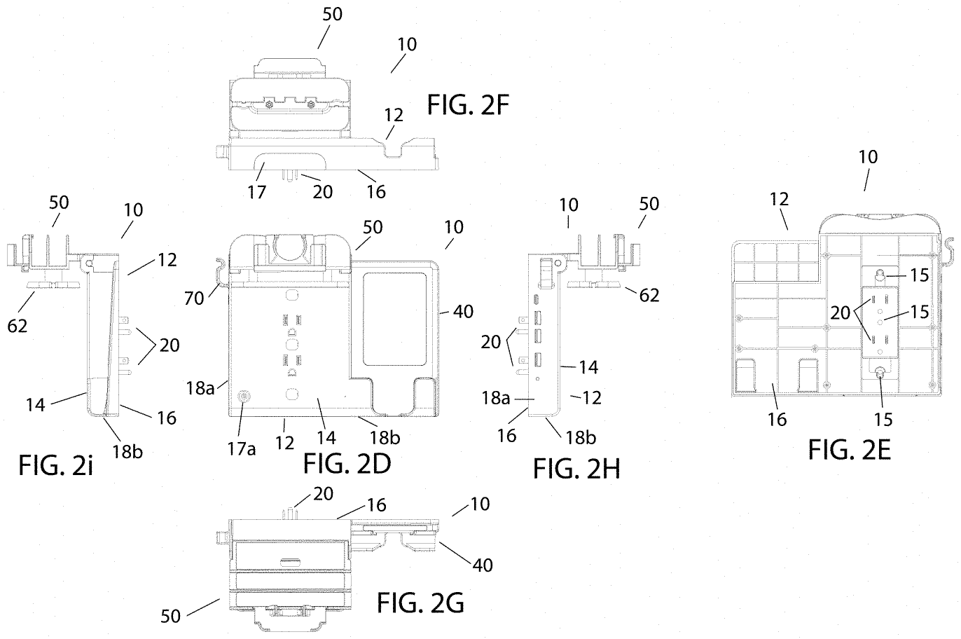

Turning to the drawings, FIGS. 1A-2D show an exemplary embodiment of a charging station 10 that generally includes a housing 12 including a front surface or panel 14 (e.g., shown in FIGS. 1A-1C), a back surface or panel 16 (e.g., shown in FIG. 1E), which may be placed against a wall or other surface, e.g., over an electrical outlet, and a plurality of side surfaces or panels 18 (e.g., side panel 18a shown in FIG. 1H), e.g., enclosing an interior of the charging station 10. The housing 12 may be formed from conventional materials, e.g., plastic, metal, or composite materials, with one or more of the panels 14-18 formed together and/or assembled together, e.g., by molding, casting, bonding with adhesive, fusing, and the like.

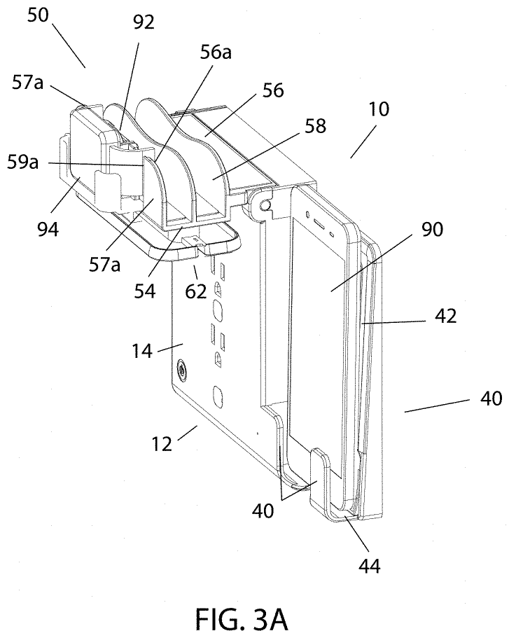

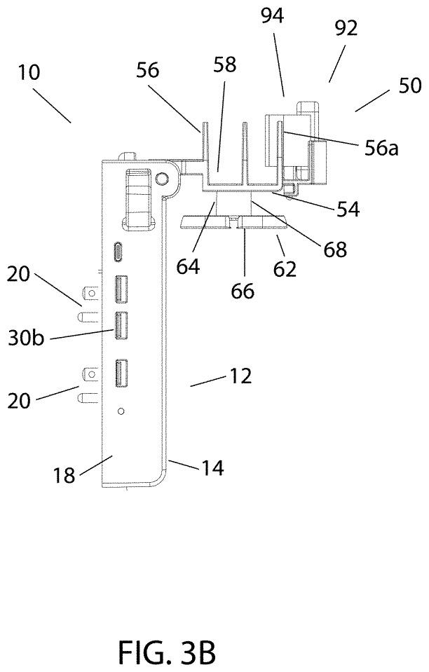

As shown in FIGS. 1G and 3B, the back surface 16 may include one or more sets of electrical plugs or prongs 20 (two shown), e.g., permanently fixed to and extending from the back surface 16, that may be received in an electrical outlet (not shown), e.g., to provide electrical power to the charging station 10. Generally, the charging station 10 includes one or more ports 30 for receiving compatible cables, e.g., one or more sockets 30a (e.g., as shown on the front surface 14) for receiving a two- or three-prong plug, one or more USB sockets 30b on a side surface 18a, e.g., a Type C USB port, as shown in FIGS. 1H and 3B, and the like. For example, as shown, the charging station 10 includes three USB ports 30b and a type C port 30c.

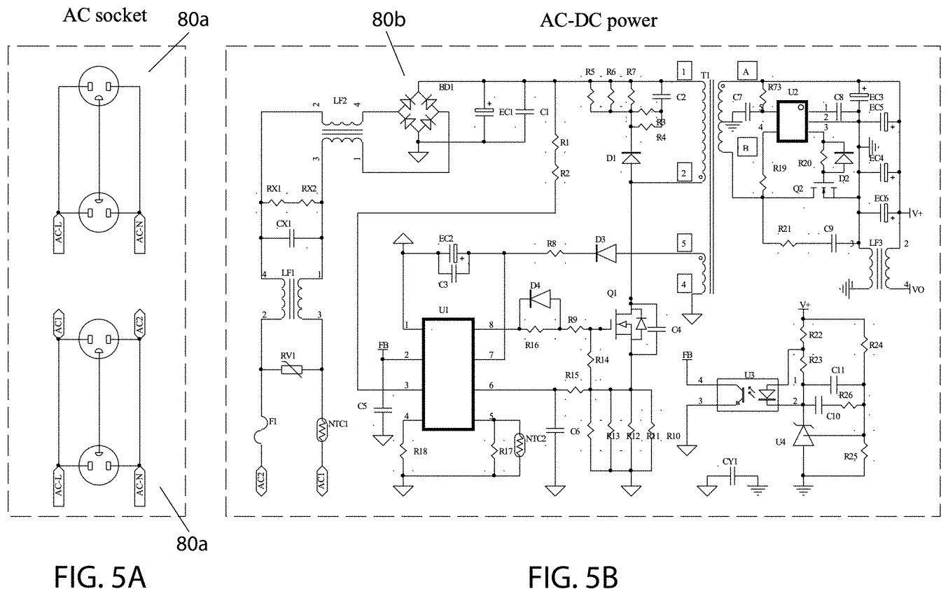

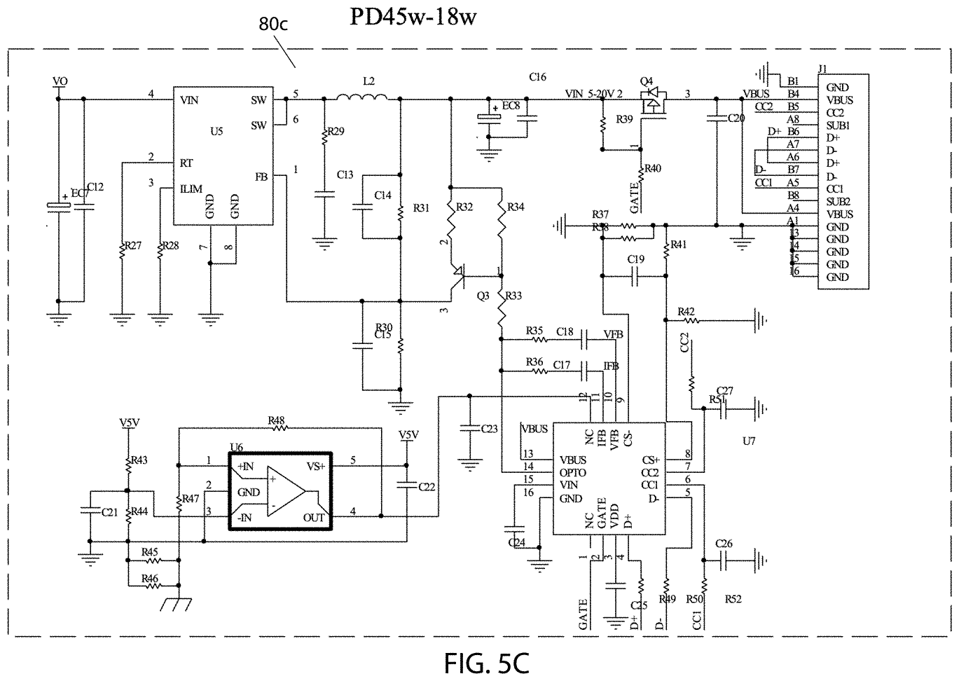

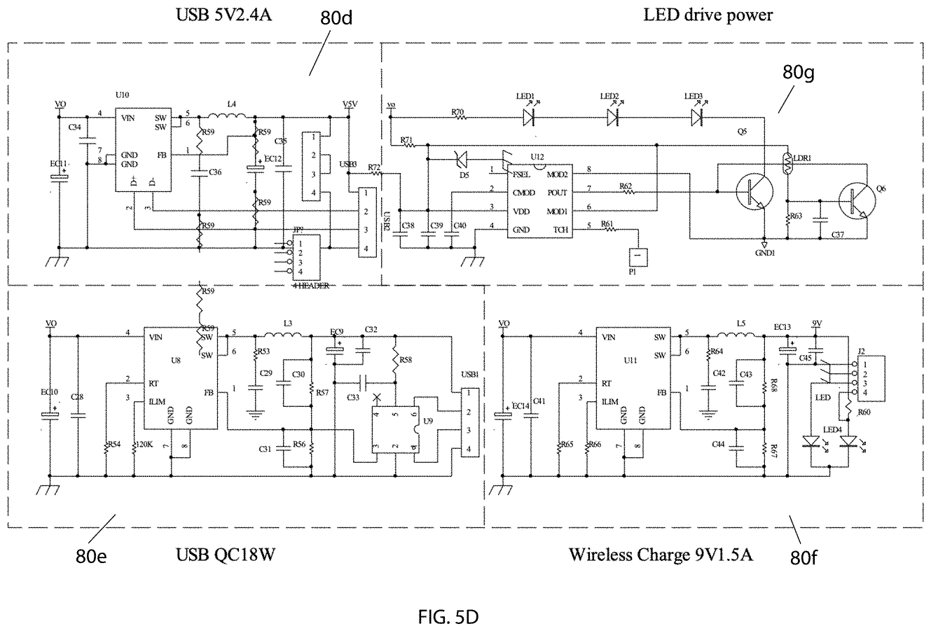

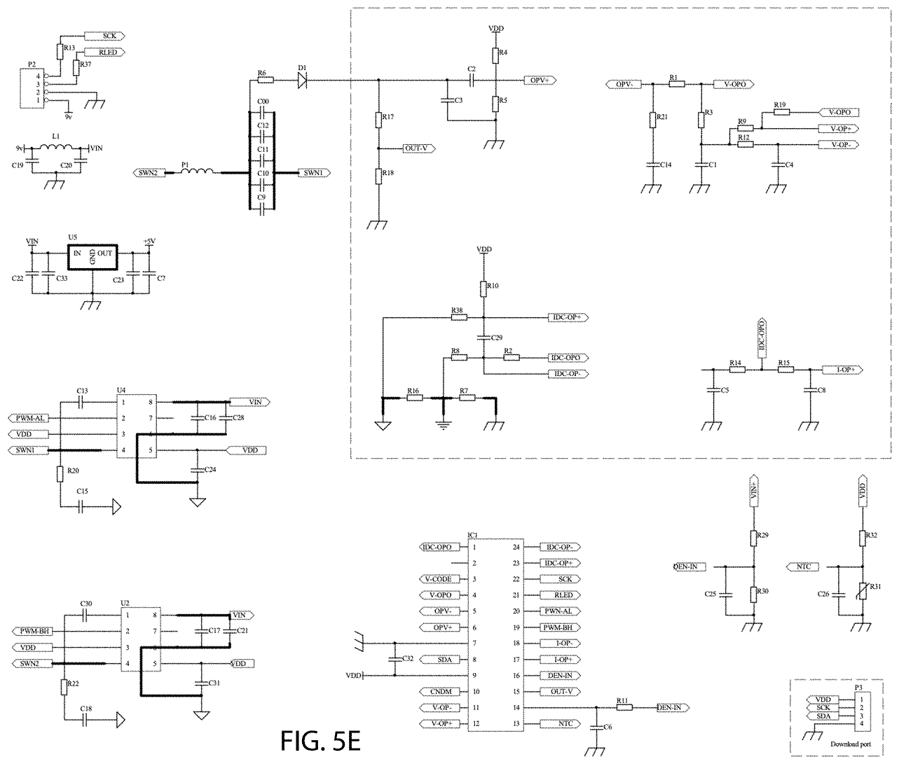

The charging station 10 also includes one or more electrical circuits (not shown) within the housing 12, e.g., a power distribution circuit for delivering electricity from the back prong(s) 20 to the various ports 30 provided on the charging station 10, such as the circuits shown in FIGS. 5A-5E. For example, FIG. 5A shows an exemplary circuit 80a coupled to the prongs 20 for distributing electricity to other circuits of the charging station 10, e.g., from an electrical wall socket (not shown) delivering 125V, 50-60 A, and a maximum power of 58 W. FIG. 5B shows an exemplary AC-DC converter circuit 80b that may receive electricity from the circuit 80a of FIG. 5A, e.g., to convert AC power into DC power, which may then be distributed to other circuits of the charging stations 10. FIG. 5C shows an exemplary power delivery circuit 80c that may be used to distribute electrical power to type C port 30c. FIG. 5D shows a set of additional circuits that may be provided within the housing 12, e.g., coupled to the AC-DC converter circuit 80b to deliver power to respective ports (or light). For example, circuits 80d, 80e may distribute power to each of the USB ports 30b, and circuit 80f may distribute power to an inductive charger 30d, as described further elsewhere herein. Circuit 80g may distribute power to one or more LEDs or other light sources, e.g., light 17, also as described further elsewhere herein.

In an exemplary embodiment, the circuits 80 may be configured to provide an adaptive power distribution circuit. For example, if only a single electronic device is connected to one of the ports 30b, 30c, the power distribution circuit may deliver maximum power to that device up to a maximum power, e.g., forty five Watts (45 W). If multiple devices are connected simultaneously, the circuits may distribute the power to the connected ports in a desired manner, e.g., up to a maximum combined power, e.g., fifty five Watts (55 W). For example, the circuits 80 may distribute power in a desired sharing contract, e.g., up to a maximum of twelve Watts (12 W) for the USB ports 30b, up to a maximum of eighteen Watts (18 W) for the type C port 30c, and up to a maximum of ten Watts (10 W) for the inductive charger without exceeding the overall maximum power. The power distribution circuit is also configured to deliver AC power to the ports 30a, e.g., at about 125V and 15 A.

Optionally, each set of prongs 20 may include a power distribution circuit electrically coupled to a separate set of ports 30, e.g., with each set coupled to the respective prong 20 in parallel with one another so that the power distribution circuit may deliver electricity to each of the ports 30 simultaneously. Alternatively, the power distribution circuit may control electrical distribution from one of the prongs to all of the available ports 30. It will be appreciated that the power distribution circuit may include one or more rigid or flexible circuit boards, to which hardware components, e.g., wires, integrated circuits, discrete components, and the like, which may be mounted within the housing 12 using conventional methods. Optionally, each power distribution circuit may also include a surge protector (not shown), e.g., to protect electronic devices being charged from surges in the electricity delivered to the charging station 10. In this manner, multiple electronic devices (not shown) may be plugged into the various ports 30 to charge the devices simultaneously using electricity from a single wall socket.

In addition, the charging station 10 may include one or more features to facilitate holding electronic devices being charged and/or to organizing cables for the devices. For example, as shown in FIG. 1A, the housing 12 may include a side tray 40 configured to hold a mobile device, such as a cellphone or tablet (not shown). In an exemplary embodiment, the side tray 40 may be integrally molded or otherwise formed as part of the housing 12 of the charging station 10. Alternatively, the side tray 40 may be formed separately and permanently attached to the housing 12, e.g., by one or more cooperating connectors, bonding, fusing, and the like. As shown, the side tray 40 includes a substantially vertical (or slightly inclined) back surface 42 and a lower ledge 44, e.g., including one or more hooks, ledges, or other features 46 to engage or contact a lower edge of an electronic device (not shown) received in the side tray 40, e.g., to prevent the device from falling out of the side tray 40 while charging. For example, as shown in FIG. 3A, a cellphone 90 may be coupled to its charging cable (not shown), placed in the side tray 40, and the charging cable plugged into an available USB port 30 on the charging station 10 to charge the cellphone. The lower ledge 44 may support the bottom of the device with the hooks 46 preventing the bottom of the device from sliding forward out of the tray 40.

In addition or alternatively, the charging station 10 may also include one or more inductive chargers built into the housing 12. For example, as shown in FIGS. 1A-1D, an inductive charger 30d (shown in phantom) may be mounted inside the housing 12, e.g., behind the back surface 42 of the side tray 40. Thus, an electronic device with wireless charging capabilities (not shown) may be placed in the tray 40 and wirelessly coupled to the inductive charger 30d for charging. If a device placed in the side tray 40 is coupled to one of the ports 30a-30c by a cable, the circuits 80 may detect this connection and not activate the inductive charger 30d but instead deliver power via the cable plugged into one of the ports 30a-30c.

The charging station 10 may also include a movable charging tray 50 that may be directed between a storage position, e.g., as shown in FIGS. 1A-1I, where the charging tray 50 is positioned out of the way, and an active position, e.g., as shown in FIGS. 1A-2I, where the charging tray 50 may provide one or more compartments for receiving one or more electronic devices for charging and/or charging cables (not shown). As shown, the charging tray 40 may be mounted to an upper edge 19 of the housing 12, e.g., by one or more hinges 52, such that the charging tray 50 may be oriented flush with the housing 12 in the storage position, and may be folded outwardly to the active position. Alternatively, the charging tray 50 may be fixedly mounted to the housing 12, e.g., extending from a desired location along the top edge, bottom edge, or one of the side edges, e.g., fixed in the active position (not shown).

The charging tray 50 may include a ledge 54 that is oriented substantially horizontally in the active position and a plurality walls or separators 56 defining slots 58 between adjacent separators 56 for receiving respective electronic devices therein. For example, in the active position shown in FIGS. 2A-2I, the ledge 54 may be oriented substantially horizontally, and the separators 56 may extend vertically from the ledge 54, e.g., substantially parallel to the front panel 14 of the housing 12. In addition, at least one of the separators 56a may include a receptacle 60 sized to receive an inductive charger 92 (not shown, see, e.g., FIGS. 3A-3B), e.g., defining an at least partially circular recess sized and/or shaped to receive the inductive charger 92. In the example shown, the receptacle 60 is provided adjacent the first slot 58a between the separator 56a and front separator 56b, e.g., such that the slot 58a is shaped to receive a watch body of a smart watch.

The receptacle 60 may define a desired shape configured to hold the inductive charger 92, e.g., defining more than half of a circle, similar to the shape of the inductive charger 92, including an open top into which the inductive charger 92 may be inserted to receive the charger 92 in the receptacle 60. For example, the material of the separator 56a may be sufficiently flexible to direct material defining the open top away to accommodate insertion of the charger 92 in the receptacle 60 and then resiliently close again to secure the charger 92 in the receptacle 60. Optionally, the receptacle 60 may include one or more tabs or other securement features around the recess, e.g., to prevent the charger 92 from sliding laterally out of the receptacle 60 after being inserted. Alternatively, the receptacle 60 may be configured to have the charger 92 inserted from the side of the separator 56a. In this alternative, the separator 56a may include one or more tabs or other features that separate to accommodate inserting the charger 92 into the receptacle 60, and then resiliently close again to secure the charger 92. The material of the tabs or features and/or the separator 56a may be sufficiently flexible to allow the inductive charger 92 to be removed from the receptacle 60, if desired.

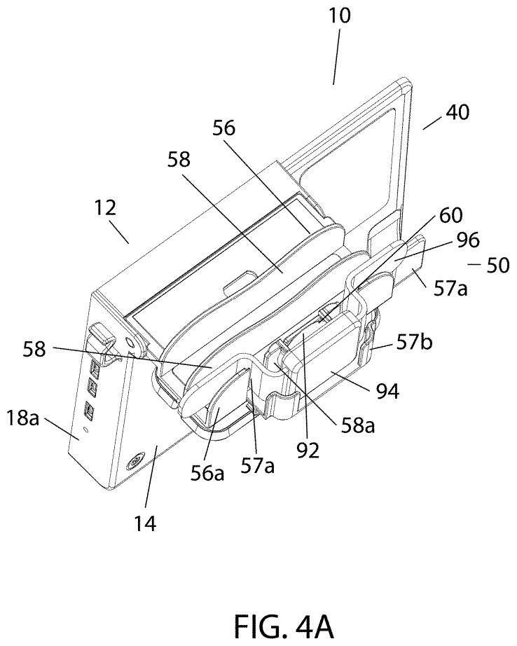

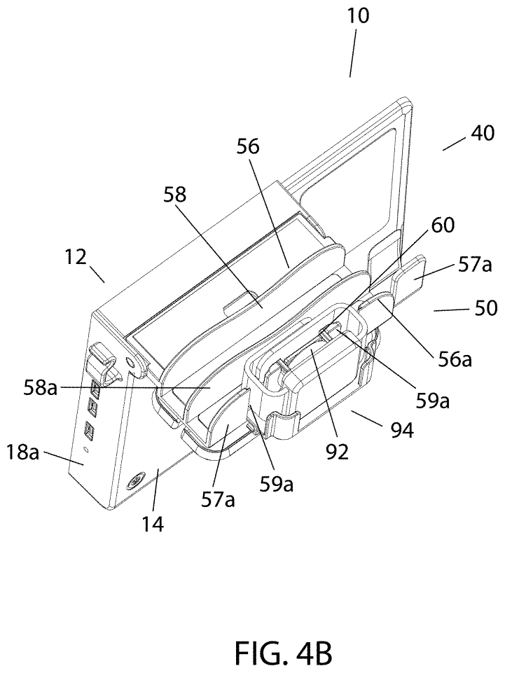

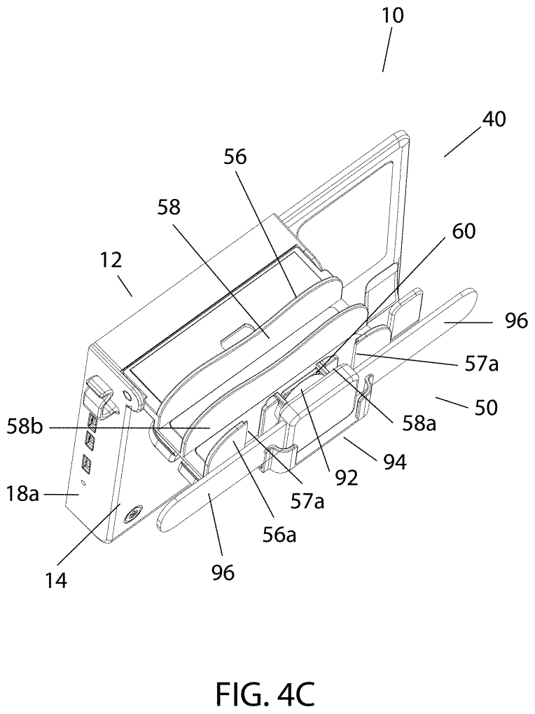

For example, as shown in FIGS. 3A-4C, an inductive charger 92 may be securely received within the receptacle 60, and its cable (not shown) plugged into an available port 30b or 30c on the housing 12. A smart watch 94, e.g., an Apple iWatch, may then be placed in the slot 58a adjacent the receptacle 60 to charge the watch 94 using the inductive charger 92, e.g., as shown in FIGS. 4A-4C. Alternatively, an electronic device (not shown) may be placed in one of the slots 58 and a charging cable coupled to the device may be plugged into an available port 30 for charging.

Optionally, as shown in FIGS. 4A-4C, the separator 56a (or any of the other separators 56, if desired) may include one or more tabs 57a such that the separator 56a includes multiple segments. For example, as shown, separator 56a include a central region including the receptacle 60 and a pair of tabs 57a on either side of the receptacle 60 that are spaced apart from the receptacle 60, thereby defining gaps 59a on either side of the receptacle 60. In addition, front separator 56b may include a pair of tabs 57b, which may be smaller than tabs 57a and/or otherwise sized and shaped to accommodate receiving a watch body.

Such a configuration may facilitate placing a smart watch or other device in the slot 58a in a variety of orientations. For example, as shown in FIG. 4A, a smart watch 94 has been placed in the slot 58a adjacent the inductive charger 92 with the watch straps 96 of the watch 94 passing through the gaps 59a into the adjacent slot 58b and extending away from one another. The watch body is secured between tabs 57b and the receptacle 60 to prevent movement off the watch 94 during charging. Alternatively, as shown in FIG. 4B, the straps 96 may pass through the gaps 59a and overlap one another in the slot 58b, e.g., such that the watch 94 may be placed adjacent the charger 92 without having to disconnect the ends of the watch strap 96. In a further alternative, shown in FIG. 4C, the watch 94 may be placed in the front slot 58a with the watch straps 96 remaining within the slot 58a and extending away from one another, e.g., which may allow the second slot 58b to be used to hold and charge another device (not shown).

In addition, the charging tray 50 may include one or more features to help organize charging cables, e.g., to hold a cable from an inductive charger placed in the receptacle 60 on the charging tray 50 (which may not be removed often). For example, as shown in FIG. 2A, a spool 62, which may be provided on a lower surface of the ledge 54 of the charging tray 50 around which one or more cables (not shown) may be wound to organize and/or minimize slack when the cables are plugged into one of the available ports 30b on the housing 12. As shown, the spool 62 includes one or more extenders 64 extending down from the ledge 54 and a flange 66 that extends horizontally from a lower end of the extender(s) 64, e.g., substantially parallel to the ledge 54, thereby defining an annular recess 68 between the flange 66 and the ledge 54. Thus, one or more cables (not shown) may be wrapped around the extender(s) 64 within the recess 68, with the flange 66 holding them in place.

In addition or alternatively, the housing 12 may include one or more spools, hooks, and/or other features to help manage cables plugged into the various ports of the charging station 10. For example, as shown in FIGS. 1B-1D, a hook 70 may be provided on side surface 18a, which may be configured to receive one or more cables. It will be appreciated that any number of such hooks or spools may be provided on any of the panels of the charging station 10, as desired, to facilitate management of cables.

Optionally, the charging station 10 may include one or more additional features. For example, a light (not shown) may be provided on the housing 12, e.g., behind a transparent or translucent cover 17 on a lower surface 18b of the housing 12, e.g., as shown in FIGS. 1F and 2F. In one embodiment, a “night” light may be provided that includes a sensor detecting when ambient light falls below a threshold, whereupon the light may automatically activate. Alternatively, a switch 17a may be provided on the housing 12, e.g., adjacent the light, that may be manually actuated by a user to turn the light on and off. Optionally, the switch may allow the light to be controlled, e.g., for example a quick press and release may turn the light on and off, while a sustained press and hold may alter a brightness of the light, e.g., cycling the light through a predetermined lightness pattern, e.g., alternately dimming and brightening the light between a minimum brightness (or off) and a maximum brightness. As shown in FIG. 5D, optionally, the light may include multiple LEDs or other light sources that may be activated/deactivated simultaneously, or may be activated alternatively.

During use, the plug(s) 20 of the charging station 10 may be plugged into an existing socket (not shown) to provide a device capable of charging and holding multiple electronic devices, e.g., for charging them simultaneously. With the charging station 10 secured into the socket, multiple cables may be plugged into the various ports 30 to charge corresponding devices. If one or more cables are to be wrapped around the spool 62, the charging tray 50 may be positioned in the storage position (if not already there), and the desired cable(s) may be wrapped around the spool 62 within the recess 68, e.g., after plugging a first end into a desired port 30. This position may facilitate wrapping the cable(s) since the spool 62 is oriented such that it extends horizontally from the charging tray 50, making it easier to wrap the cable(s) clockwise or counterclockwise around the spool 62. Once the desired cable(s) are wrapped, sufficient length of the loose end may be provided to connect the cable(s) to the device(s) to be charged. Thus, the spool 62 may be used to help organize multiple cables that are to be connected to different devices. The circuits 80 may distribute power from the electrical socket to the one or multiple devices, as described elsewhere herein, e.g., to charge multiple devices simultaneously.

The charging tray 50 may then be rotated down to the active position, such that the ledge 54 is substantially horizontal, whereupon one or more devices may be plugged into the corresponding cable(s) and placed in one of the slots 58.

To install an inductive charger 92, the charging tray 50 may be positioned in the active position (if not already), and the inductive charger 92 may be inserted into the receptacle 60, e.g., as shown in FIGS. 3A and 3B. The cable (not shown) for the inductive charger 92 may then be wrapped around the spool 60, e.g., after moving the charging tray 50 to the storage position, leaving sufficient length of the cable to plug into the device. The charging tray 50 may be moved back to the active position, and the device, e.g., a smart watch 94 as shown in FIGS. 4A-4C, may then be connected to the cable and placed in the first slot 58a for charging.

In one embodiment, the charging station 10 may replace a cover plate of a conventional electrical socket. For example, a charging station 10 including two plugs may replace a cover plate of a two-plug electrical socket. The housing 12 may include openings 15 (shown in FIGS. 1E and 2E, e.g., behind removable covers 15a on the front panel 14, as shown in FIGS. 1A and 1D, that extend through the front and back panels 14, 16 that align with screw holes in an electrical socket box when the cover plate is removed (not shown) such that longer screws may be inserted through the openings and screwed into the existing socket box. For example, after removing the socket cover plate, a pair of the openings 15 may be exposed (by removing covers 15a) that are spaced apart similar to the screw holes in the electrical box, and corresponding screws threaded through the openings 15 into the screw holes, e.g., to securely fix the charging station 10 to the wall.

The foregoing disclosure of the exemplary embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

It will also be appreciated that elements or components shown with any embodiment herein are exemplary for the specific embodiment and may be used on or in combination with other embodiments disclosed herein.

Further, in describing representative embodiments, the specification may have presented the method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A charging station for charging electronic devices, comprising:
a housing comprising a front panel, one or more side panels, and a back panel opposite the front panel including one or more electrical connectors, the back panel configured for placement against a surface adjacent an electrical outlet such that the one or more electrical connectors may be coupled to one or more respective sockets of the electrical outlet;
one or more ports on one or both of the front panel and the one or more side panels configured to receive connectors from charging cables from electronic devices;
a power distribution circuit within the housing for delivering electricity from the electrical outlet via the one or more electrical connectors to the one or more ports; and
a charging tray mounted to the housing such that the charging tray is movable between a storage position and an active position, the charging tray comprising one or more separators defining slots between adjacent separators for receiving one or more electronic devices for charging.

2. The charging station of claim 1, wherein the charging tray is connected to the housing by one or more hinges such that the charging tray is rotatable relative to the housing between the storage and active positions.

3. The charging station of claim 1, wherein the charging station includes a ledge that is oriented substantially parallel to the front panel in the storage position and is oriented substantially perpendicular to the front panel in the active position.

4. The charging station of claim 3, wherein a plurality of separators are fixed to the ledge such that the separators are spaced apart from one another on the ledge and extend substantially perpendicular to the ledge.

5. The charging station of claim 4, wherein the separators are oriented substantially parallel to the front panel when the charging tray is in the active position.

6. The charging station of claim 3, further comprising a spool attached to the charging tray below the ledge.

7. The charging station of claim 6, wherein the spool comprises one or more extenders extending from the ledge on a side opposite the separators and a flange extending from the one or more extenders substantially parallel to the ledge, thereby defining a recess between the ledge and the flange for receiving one or more cables wrapped around the one or more separators.

8. The charging station of claim 4, wherein the charging tray comprises a receptacle in a first separator of the plurality of separators configured to receive an inductive charger, the receptacle located adjacent a first slot adjacent the first separator such that an electronic device placed within the first slot is located adjacent the receptacle and may be inductive charged by an inductive charger placed in the receptacle.

9. The charging station of claim 8, further comprising an inductive charger received in the receptacle.

10. The charging station of claim 9, further comprising spool on the charging station below the ledge, and wherein a cable of the inductive charger is wrapped one or more times around the spool.

11. The charging station of claim 8, wherein the first separator includes a pair of tabs extending from the ledge that are spaced apart from the receptacle to define gaps to accommodate a watch band of a watch being extended through the gaps when the watch is placed in the first slot adjacent the receptacle.

12. The charging station of claim 1, further comprising an inductive charger mounted to a first separator of the charging tray adjacent a first slot of the one of the slots such that an electronic device placed within the first slot may be inductive charged by the inductive charger.

13. The charging station of claim 1, wherein the one or more ports comprise a USB port.

14. The charging station of claim 1, wherein the one or more ports comprise plurality of USB ports on a first side panel of the housing.

15. The charging station of claim 1, wherein the one or more ports comprise a two- or three-prong electrical socket.

16. The charging station of claim 15, wherein the one or more ports comprise a pair of electrical sockets on the front panel.

17. The charging station of claim 1, further comprising an inductive charger mounted within the housing adjacent one of the front panel or one of the one or more side panels such that an electrical device placed adjacent the inductive charger may be charged without a cable.

18. The charging station of claim 1, further comprising a light coupled to the power distribution circuit such that electricity from the electrical outlet is delivered to the light.

19-24. (canceled)

25. A method for mounting a charging station comprising a housing including a front panel, a back panel opposite the front panel that includes one or more electrical connectors, and one or more ports electrically coupled to one or more electrical connectors for charging one or more electronic devices connected to the one or more ports, the method comprising:
removing a cover plate of an electrical outlet in a wall;
inserting the one or more electrical connectors into respective one or more sockets of the electrical outlet;
placing the back surface adjacent the wall;
directing a fastener into an opening in the housing through the front and back panels, and into a fastener hole in the electrical outlet to secure the housing relative to the wall.

26-51. (canceled)

52. A method for charging one or more electronic devices, comprising:
providing a charging station comprising a housing including a front panel, one or more side panels, a back panel opposite the front panel that includes one or more electrical connectors, one or more ports electrically coupled to one or more electrical connectors, and a charging tray mounted to the housing such that the charging tray is movable between a storage position and an active position, the charging tray comprising a ledge and a plurality of separators fixed to the ledge such that the separators are spaced apart from one another on the ledge and extend substantially perpendicular to the ledge;
inserting the one or more electrical connectors into respective one or more sockets of the electrical outlet;
placing the back surface adjacent the wall;
connecting a cable to a first port of the one or more ports;
connecting the cable to an electronic device to charge the electronic device;
positioning the charging tray in the active position wherein the ledge is oriented substantially perpendicular to the front panel and the separators are oriented substantially parallel to the front panel; and
placing the electronic device in a slot adjacent one of the separators.

53-60. (canceled)
